(19) United States
(12) Patent Application Publication
(10) Pub. No.: US 2025/0024186 A1
(43) Pub. Date: Jan. 16, 2025

(54) Earband Type Earphone

(71) Applicant: Yuanhao Liu, Shenzhen (CN)

(72) Inventor: Yuanhao Liu, Shenzhen (CN)

(21) Appl. No.: 18/766,658

(22) Filed: Jul. 9, 2024

(30) Foreign Application Priority Data
Jul. 10, 2023 (CN) 2023108387191

(51) Int. Cl. H04R 1/10

(52) U.S. Cl. CPC H04R 1/105; H04R 1/1016; H04R 1/1083; H04R 2400/01

(57) ABSTRACT

An earband type earphone includes a wearing part; an earlobe retention part; and a connecting part; the connecting part is connected between the wearing part and the earlobe retention part, so that the wearing part is suitable for being suspended at a position corresponding to the tragus of the ear, and a clamping cavity is formed by the earlobe retention part, so that the earlobe is suitable for being located in the clamping cavity and being clamped by the earlobe retention part.

### CROSS REFERENCE OF RELATED APPLICATION

This application is a non-provisional application that claims priority under 35U.S.C. § 119 to China application number CN202310838719.1, filing date Jul. 10, 2023, wherein the entire content of which is expressly incorporated herein by reference.

### BACKGROUND OF THE PRESENT INVENTION

### Field of Invention

The present invention relates to the field of earphone technology, particularly to an earband type earphone.

### Description of Related Arts

earphones, as audio playback devices, are widely used and have become indispensable electronic products in people's daily lives. At present, there are various types of earphones on the market, which can be divided into wired earphones and wireless earphones based on the communication method between the earphones and terminal devices; According to the way earphones are worn, they can be divided into in ear earphones, head mounted earphones, and over ear earphones.

However, there are currently some shortcomings in the earphones on the market. For example, wired earphones are not easy to store, and the electrical connection cable of the earphones used to connect to terminal devices is easily damaged, and it is also easy to get entangled with other components or external devices.

In ear earphones, although small in size, are easy to carry. However, as the name suggests, in ear earphones are the earphones that need to be inserted into the wearer's external ear canal during use. Wearing in ear earphones for a long time can cause discomfort and pose a risk of hearing loss, and can also lead to ear diseases due to the growth of bacteria in the earphones. Some in ear earphones have their sound producing parts almost completely inserted into the external ear canal, resulting in a high degree of insulation from external sound and being prone to accidents in some situations.

There are also some semi in ear earphones on the market that are worn on the outer auricle during use. However, the current semi in ear earphones have poor wearing stability and are prone to falling off when the wearer engages in extensive exercise.

Headworn earphones have good sound and sound insulation effects, strong sound quality, and an immersive effect. However, the size of earphones is relatively large, making them inconvenient to carry and store, and requiring more power to drive them; And there may also be a problem of strong sound insulation that prevents the wearer from hearing external sounds, which can easily lead to accidents.

Compared to headworn earphones, ear mounted earphones have advantages such as good fixation, strong privacy, affordable price, and adjustable sound insulation. However, ear mounted earphones have drawbacks such as poor comfort, inferior sound quality and noise reduction compared to headworn earphones. And ear mounted earphones can affect the wearing of other wearing items, such as hearing aids, as well as other ear wearing items such as earrings.

### SUMMARY OF THE PRESENT INVENTION

The present invention is advantageous in that it provides an earband type earphone, wherein the wearing part of the earband type earphone is suitable for wearing at the tragus of the wearer, without the need to insert into the ear canal and close the ear canal, which can improve its wearing comfort, achieve painless wearing, and enhance the wearer's experience.

Another advantage of the present invention is to provide an earband type earphone, wherein the earband type earphone does not need to be inserted into the ear canal to seal the ear canal, and can also avoid the generation of bacteria in the ear canal of the wearer due to insert into the ear canal directly, leading to disease infection in the wearer's ear canal.

Another advantage of the present invention is to provide an earband type earphone, wherein the earband type earphone does not need to be inserted into the ear canal and closes the ear canal, which can to some extent avoid damage to the wearer's hearing.

Another advantage of the present invention is to provide an earband type earphone, wherein the earband type earphone does not need to be inserted into the ear canal and closes the ear canal, allowing the wearer to receive both the sound inside the earphone and the external sound. This can to some extent reduce the danger of use caused by poor reception of external sound by the wearer.

Another advantage of the present invention is to provide an earband type earphone, wherein the earband type earphone is designed according to the structure of the human ear, conforms to ergonomic design, is suitable for fixing along the wearer's helix on the wearer's ear, has a large contact area, and fits well with the wearer's ear. This can improve the wearing stability of the earband type earphone, make it not easy to fall off, and also improve wearing comfort.

Another advantage of the present invention is to provide an earband type earphone, wherein the earlobe retention part of the earband type earphone can be stably clamped on the wearer's earlobe, further improving the wearing stability of the ear loop earphone and making it less prone to detachment.

Another advantage of the present invention is to provide an earband type earphone, wherein the earband type earphone has a wearing space that can be adjusted in size during initial wear to adapt to different ear types of wearers and fit more tightly with the wearer's auricle, making it less likely to fall off.

Another advantage of the present invention is to provide an earband type earphone, wherein the earband type earphone is easy to wear and remove.

Another advantage of the present invention is to provide an earband type earphone, wherein in some embodiments, the earband type earphone is at least partially elastic and can be tightly fitted to the wearer's ear after being stretched and adjusted to a specific position during the wearing process.

Another advantage of the present invention is to provide an earband type earphone, wherein the accommodating space of the wearing part at the upper edge of the tragus suitable for being worn on the ear is mainly used for assembling a sounding unit, and the battery and circuit board are assembled into the accommodating space of the earlobe retention part suitable for being worn on the ear lobe; Compared to the design in existing technology, where the battery, circuit board, and sound unit are all installed in the wearable part of the earphone suitable for wearing inside the helix, the earband type earphone in this invention has a larger space for accommodating the sound unit, allowing for the use of large-sized sound components, thereby improving the sound quality effect.

Another advantage of the present invention is to provide an earband type earphone, wherein the outer surface of the earband type earphone can be decorated with decorative elements, such as diamonds, pearls, colored gems, embossed patterns, textures, etc., allowing the earband type earphone itself to be used as an earring.

Another advantage of the present invention is to provide an earband type earphone, wherein in some embodiments, the earband type earphone can be equipped with a hearing aid unit, enabling the earband type earphone to be compatible with hearing aid functions, thereby avoiding the inconvenience of hearing impaired wearers being unable to wear hearing aids while wearing the earband type earphone.

Another advantage of the present invention is to provide an earband type earphone, wherein the earband type earphone integrates an artificial intelligence module, which can improve its interaction with the terminal device and the wearer. For example, by interacting with the terminal device, it can not only control the playback of audio and video, make phone calls, but also provide network information to the wearer, conduct online shopping, send emails, control home or office equipment, etc.

Additional advantages and features of the present invention will become apparent from the description which follows, and may be realized by means of the instrumentalities and combinations particular point out in the appended claims.

In order to achieve at least one advantage or other advantage and purpose as described above, according to one aspect of the present invention, an earband type earphone is provided, comprising: a wearing part, an earlobe retention part, and a connecting part; wherein the connecting portion is connected between the wearing portion and the earlobe retention portion, so that the wearing part is suitable for being suspended at a position corresponding to the tragus. The earlobe retention part forms a clamping cavity, so that the earlobe is suitable for being located in the clamping cavity and clamped by the earlobe retention part.

In a preferred embodiment of the present invention, when the user wears the earband type earphone, the end of the connecting portion of the earband type earphone is located at the foot of the helix, and the wearing part is located below one end of the connecting part.

In a preferred embodiment of the present invention, the upper part of the connecting part adjacent to the wearing part surrounds the front side of the helix of the ear, and the lower part of the connecting part surrounds the rear ear side of the ear.

In a preferred embodiment of the present invention, the wearing part comprises a wearing body and a sounding unit. The wearing part has a first containment space, and the sounding unit is accommodated within the first containment space. When the user wears the earband type earphone, the sounding unit corresponds to the canvum conchae of the ear.

In a preferred embodiment of the present invention, the earlobe retention part comprises a first clamping body, a second clamping body, and a connecting element. A clamping cavity is enclosed by the first clamping body, the second clamping body and the connecting element. The clamping cavity is suitable for clamping the earlobe of the ear, wherein the first clamping body is located at the rear side of the earlobe, and the second clamping body is located at the front side of the earlobe.

In a preferred embodiment of the present invention, when the user wears the earband type earphone, the second clamping body is constructed to have a decorative effect.

In a preferred embodiment of the present application, the earlobe retention part has a second containment space, and the earband type earphone further comprises a power supply unit and a control unit, wherein the power supply unit and the control unit are accommodated in the second containment space.

In a preferred embodiment of the present invention, a wearing space formed by the wearing part, the connecting part, and the earlobe retention part, and the size of the wearing space is adjustable.

In a preferred embodiment of the present invention, the connecting part is made of deformable material, so that the size of the wearing space can be adjusted.

In a preferred embodiment of the present invention, the connecting part is elastic.

In a preferred embodiment of the present invention, the earband type earphone further comprises a control unit, a hearing aid unit, the control unit comprising a control circuit board and at least a control operating element, and the hearing aid unit is electrically connected to the control circuit board.

In a preferred embodiment of the present invention, the earband type earphone further comprises a control unit, the control unit comprising a control circuit board and at least a control operating element, wherein the control circuit board is integrated with at least a microphone and an artificial intelligence module.

In a preferred embodiment of the present invention, the connecting part comprises a connecting body, the connecting portion has a wiring channel, and the wiring channel is formed within the connecting body.

In a preferred embodiment of the present invention, the connecting part comprises a connecting body, the connecting portion has a wiring channel, the wiring channel is concavely formed on the outer surface of the connecting body.

In a preferred embodiment of the present invention, the earband type earphone comprises at least a decorative element, which is provided on a portion of the surface of the wearing part, the connecting part, or the earlobe retention part.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of the earband type earphone according to an embodiment of the present invention.

FIG. 2 is another perspective view of the earband type earphone according to an embodiment of the present invention.

FIG. 3 is another one perspective view of the earband type earphone according to an embodiment of the present invention.

FIG. 4 is an exploded view of the earband type earphone according to an embodiment of the present invention.

FIG. 5 is a schematic view of shape adjustment of the earband type earphone according to an embodiment of the present invention.

FIG. 6 is a wearing view of the earband type earphone according to an embodiment of the present invention.

FIG. 7 is another wearing view of the earband type earphone according to an embodiment of the present invention.

FIG. 8 is a perspective view of a modified embodiment of the earband type earphone according to an embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

The present invention provides an earband type earphone 1, which refers to a earphone that can be worn in the following way on ear E: one end is located at the tragus E11 on the front ear side of ear E, and the other end is located on the back ear side of ear E. The upper part of the part between the two ends of the earphone is wrapped around the front side of helix E12, and the lower part is wrapped around the back side of helix E12, and is wrapped on ear E in this way. The earband type earphone 1 is worn in the wearer's ear E according to the above wearing method, which can improve its wearing comfort and stability.

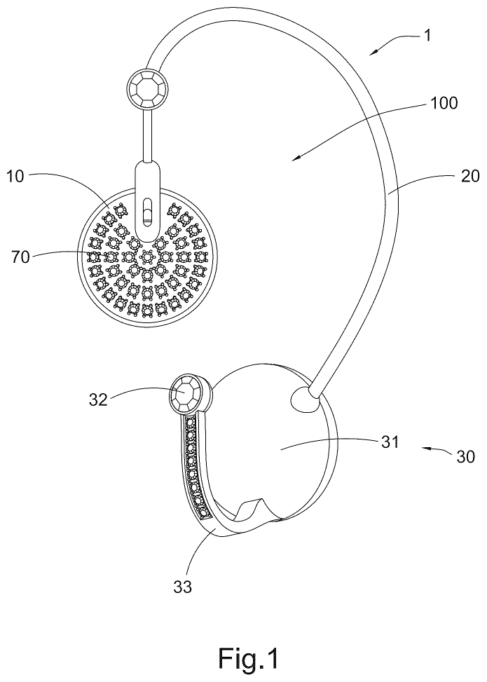

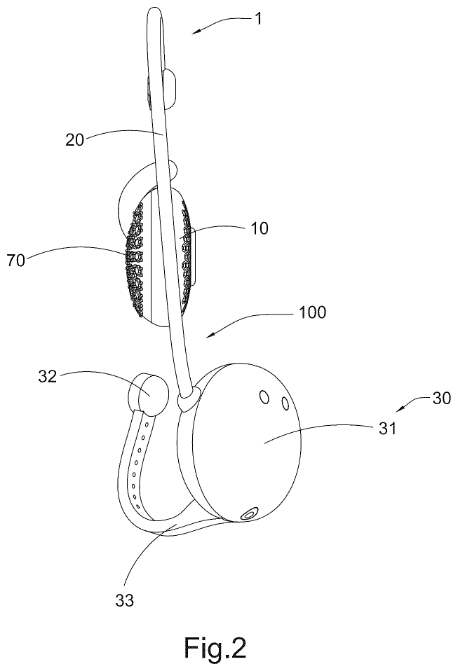

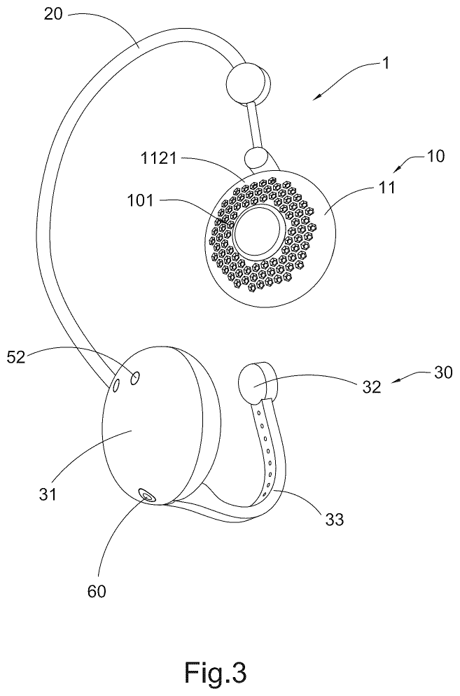

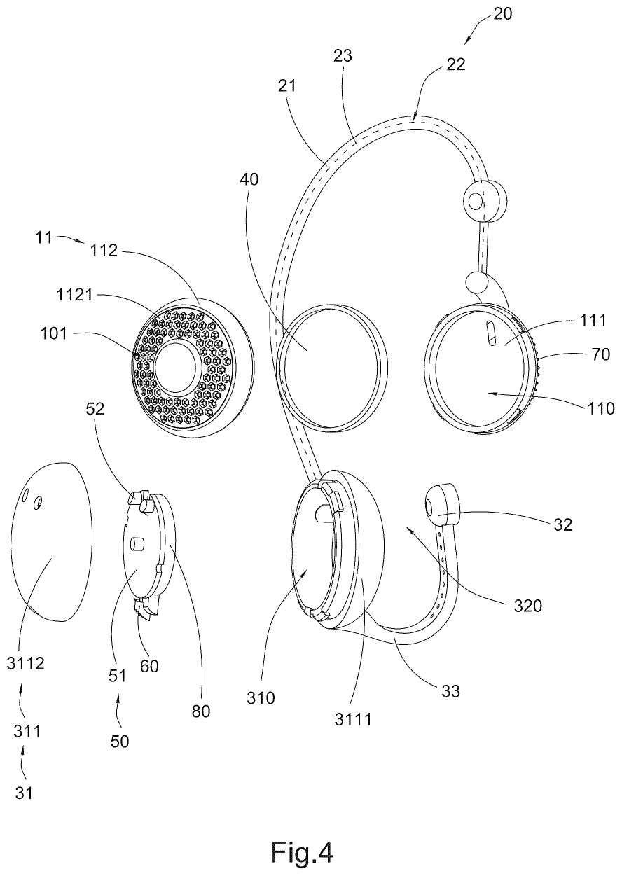

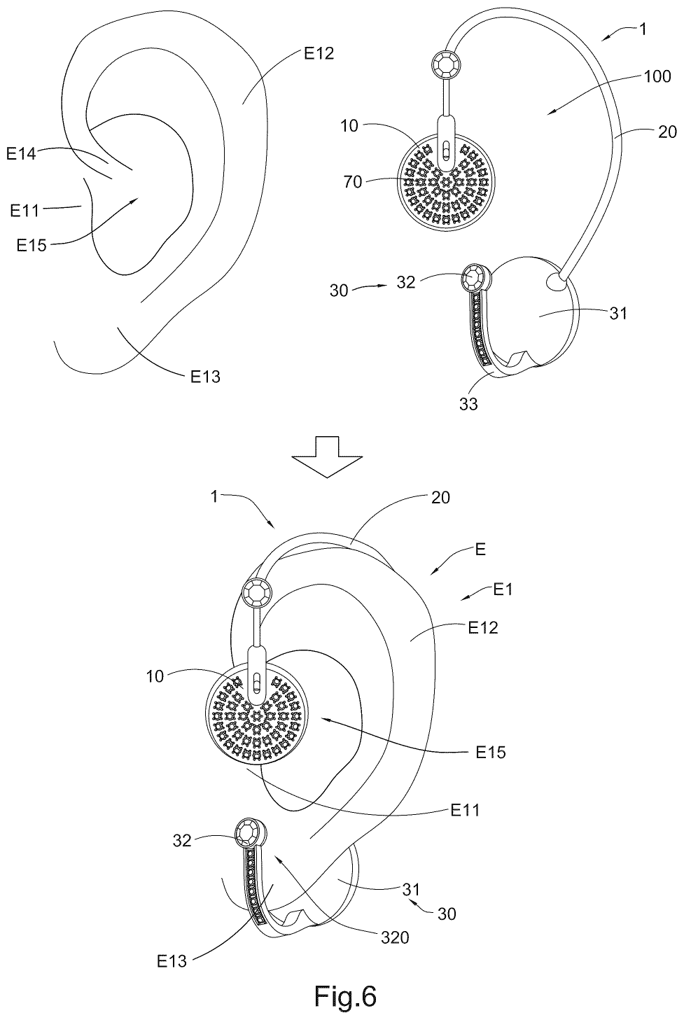

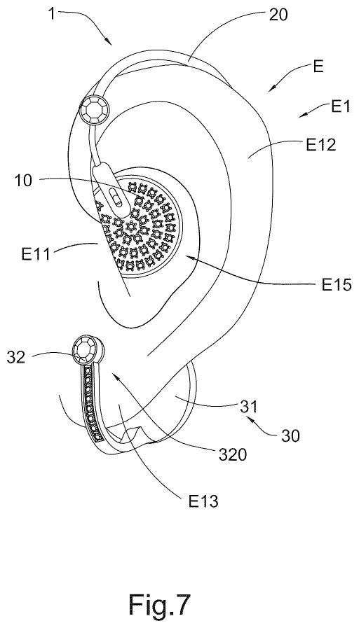

As shown in FIGS. 1 to 7 in the present invention, the earband type earphone 1 according to the embodiments of the present invention will be explained in the following description. In the embodiments of the present invention, the earband type earphone 1 comprises a wearing part 10, a connecting part 20, and an earlobe retention part 30, wherein the connecting part 20 extends between the wearing part 10 and the earlobe retention part 30. That is to say, one end of the connecting part 20 is connected to the wearing part 10, and the other end is connected to the earlobe retention part 30.

For clarity, in this embodiment, the side with the wearing part 10 is considered as the upper side of the earband type earphone 1, and the side with the earlobe retention part 30 is considered as the lower side of the earband type earphone 1. When worn on the ear E, the inner side of the earband type earphone 1 is the side facing the ear, and the outer side of the earband type earphone 1 is the side away from the ear E.

The earband type earphone 1 is designed according to the structure of the human ear and conforms to ergonomic design. It is suitable to be fixed along the wearer's helix E12 on the wearer's ear E, with a large contact area and a relatively close fit with the wearer's ear E. This can improve the wearing stability of the earband type earphone 1, make it not easy to fall off, and also improve wearing comfort.

Specifically, as shown in FIGS. 1 to 3, the overall shape of the earband type earphone 1 is similar to the outer contour of the ear E, and the shape of the connecting part 20 is the shape of the helix E12. When the earband type earphone 1 is worn on the wearer's ear E, the wearing part 10 is suitable for hanging at a position corresponding to the tragus E11 of the ear E, the connecting part 20 is suitable for surrounding the wearer's helix E12, and the earlobe retention part 30 is at least partially located on the posterior ear side of the ear E.

The implementation method of the wearing part 10 suitable for being hung on the ear E corresponding to the position of the tragus E11 is not limited by the present invention. For example, when the earband type earphone 1 is worn on the wearer's ear E, the connecting portion 20 is connected to the end of the wearing part 10, that is, the upper end, located at the foot of the helix E12. The connecting portion 20 is adjacent to the upper part of the wearing portion 10 and surrounds the front side of the helix E12 of the ear E, roughly extending along the front side of the upper part of the helix E12; The lower part of the connecting part 20 wraps around the back side of the ear E and roughly extends along the rear side of the lower part of the helix E12; In this way, the wearing part 10 located below the upper end of the connecting part 20 is suspended at a position corresponding to the tragus E11 on the front ear side of the ear E, and the earlobe retention part 30 connected to the lower end of the connecting part 20 is at least partially located on the rear ear side of the ear E.

It is worth mentioning that the wearing part 10 of the earband type earphone 1 is suitable for hanging at the wearer's tragus E11, without inserting it into the ear canal and seal it, which can improve its wearing comfort, achieve painless wearing, and enhance the wearer's experience; It can also avoid generating the bacteria in the wearer's ear canal caused by direct insertion, leading to disease and infection in the wearer's ear canal; It can also to some extent avoid causing hearing damage to the wearer. In addition, the earband type earphone 1 does not need to be inserted into the ear canal, allowing the wearer to receive both the sound inside the earphone and the external. This can to some extent reduce the danger of use caused by the wearer's poor reception of external sound.

In this embodiment, the wearing part 10 comprises a wearing body 11 and a sounding unit 40. The wearing part 10 has a first containment space 110, and the sounding unit 40 is accommodated within the first containment space 110. When the wearer wears the earband type earphone 1, the sounding unit 40 corresponds to the tragus E11 or cavum conchae of the ear E, so that the wearer can receive the sound emitted by the sounding unit 40 through bone conduction or air conduction.

The wearing body 11 has a wearing surface 1121 and at least a noise reduction hole 101. When the earband type earphone 1 is worn on the wearer's ear E, the wearing surface 1121 is faced to the front ear side of the ear E; The sounding unit 40 is oriented towards the wearing surface 1121 to propagate the vibration sound effect to the eardrum of the wearer's ear E; The noise reduction hole 101 is formed on the wearing surface 1121 and is connected between the first containment space 110 of the wearing body 11 and the outside world, in order to avoid the sounding unit 40 inside the wearing body 11 from generating unstable air pressure due to vibration and provide physical noise reduction.

The sounding unit 40 provides a function of sound output, and its specific implementation is not limited by the present invention. The sounding unit 40 can be implemented as various speakers that can produce sound effects, such as dynamic coil speakers, dynamic iron speakers, flat diaphragm speakers, electrostatic diaphragm speakers, etc. Taking a dynamic coil speaker as an example, the sounding unit 40 correspondingly includes components such as a bracket, a magnetic return system, a voice coil, and a diaphragm. In addition, the sounding unit 40 can also be implemented as a bone conduction speaker.

Furthermore, in this embodiment, the wearing body 11 comprises a first wearing shell 111 and a second wearing shell 112. The first wearing shell 111 has a first wearing shell opening, and the second wearing shell 112 has a second wearing shell opening. The first wearing shell 111 is connected to the second wearing shell 112, and the the first wearing shell opening is opposite to the second wearing shell opening, so that to enclose to form the first containment space 110. When earband type earphone 1 is worn on the wearer's ear E, the first wearing shell 111 is away from the front side of the ear E, the second wearing shell 112 is facing the front side of the ear E, and the wearing surface 1121 is formed on the second wearing shell 112.

The first wearing shell 111 and the second wearing shell 112 can be an integrated structure, for example, the first wearing shell 111 is integrally formed with the second wearing shell 112, or the first wearing shell 111 is fused with the second wearing shell 112; The first wearing shell 111 and the second wearing shell 112 can be in a split structure and can be connected to each other through a buckle structure, a buckle structure, and other structures.

The connecting part 20 can be integrally connected to the first wearing shell 111 or the second wearing shell 112, for example, the first wearing shell 111 or the second wearing shell 112 is integrally formed with the connecting part 20, or the first wearing shell 111 or the second wearing shell 112 is fused with the connecting part 20. The connecting part 20 can also be connected to the first wearing shell 111 or the second wearing shell 112 through other means, such as hinge connection, damping connection, snap connection, and latch connection.

The earlobe retention part 30 includes a first clamping body 31, a second clamping body 32, and a connecting element 33, which is connected between the first clamping body 31 and the second clamping body 32. The first clamping body 31, the second clamping body 32 and the connecting element 33 are enclosed to form a clamping cavity 320. The clamping cavity 320 is suitable for clamping the earlobe E13 of the ear E. When earband type earphone 1 is worn on the user's ear, the first clamping body 31 is located behind the earlobe E13, and the second clamping body 32 is located on the front side of the earlobe E13. The shape of the clamping cavity 320 is close to a U-shape and has an upward opening. That is, when wearing the earband type earphone 1 on ear E, the earlobe E13 of ear E can be extended into the clamping cavity 320 from the upward opening of the clamping cavity 320, or the earlobe E13 of ear E can be inserted into the clamping cavity 320 from one side of the clamping cavity 320, such as the left or right side.

It is worth mentioning that the second clamping body 32 is further constructed into a decorative shape, thereby providing a decorative effect. For example, the second clamping body 32 can be constructed as a circular, star shaped, heart-shaped, etc. Its outer surface can be set with diamonds, pearls, colored treasures, relief patterns, textures, etc., thereby further enhancing the aesthetic effect.

The first clamping body 31 comprises a first clamping element 311, and the first clamping body 31 has a second containment space 310 formed within the first clamping element 311. The first clamping element 311 comprises a first clamping shell 3111 and a second clamping shell 3112. The first clamping shell 3111 has a first clamping shell opening, and the second clamping shell 3112 has a second clamping shell opening. The first clamping shell 3111 is connected to the second clamping shell 3112, and the first clamping shell opening is opposite to the second clamping shell opening to enclose to form the second containment space 310. When earband type earphone 1 is worn on the wearer's ear E, the first clamping shell 3111 is faced the front side of the ear E, and the second clamping shell 3112 is away from the front side of the ear E.

The first clamping shell 3111 and the second clamping shell 3112 can be formed as an integrated structure, for example, the first clamping shell 3111 is integrally formed with the second clamping shell 3112, or the first clamping shell 3111 is fused with the second clamping shell 3112; The first clamping shell 3111 and the second clamping shell 3112 can be in a split structure and can be connected to each other through a buckle structure, a buckle structure, and other structures.

The connecting part 20 can be integrally connected to the first clamping shell 3111 or the second clamping shell 3112, for example, the first clamping shell 3111 or the second clamping shell 3112 is integrally formed with the connecting part 20, or the first clamping shell 3111 or the second clamping shell 3112 is fused with the connecting part 20. The connecting part 20 can also be connected to the first clamping shell 3111 or the second clamping shell 3112 through other means, such as hinge connection, damping connection, snap connection, and latch connection.

A wearing space 100 is formed by the wearing part 10, the connecting part 20, and the earlobe retention part 30. Preferably, the size of the wearing space 100 is adjustable, so that the earband type earphone 1 can be adapted to different ear shapes of the wearer and fit more tightly with the wearer's auricle E1, making it less prone to detachment.

The specific implementation method of the adjustable size of the wearing space 100 is not limited by the present invention. For example, in this embodiment of the present invention, the connecting part 20 is made of deformable material, so that the outer contour of the connecting part 20 can be adjusted according to needs, thereby making the size of the wearing space 100 can be adjusted. While the connecting part 20 undergoes deformation, the relative positions of the wearing part 10 and the earlobe retention part 30 connected to both ends of the connecting part 20 can be adjusted, so that the wearing part 10 and the earlobe retention part 30 are adjusted to the expected position during the wearing process of the earband type earphone 1.

Furthermore, the connecting part 20 can be made of elastic material, and during the wearing process of the earband type earphone 1, the connecting part 20 can be stretched and adjusted to a specific position, and can tightly fit onto the wearer's car E.

Alternatively, the first wearing shell 111 of the wearing part 10, the connecting part 20, and the first clamping shell 3111 of the first clamping body 31 can be integrally formed from the same material. Specifically, the first wearing shell 111 of the wearing part 10, the connecting part 20, and the first clamping shell 3111 of the first clamping body 31 are made of hard or clastic materials. Preferably, they are formed by integrating materials with ductility. For example, materials made of copper, silver, stainless steel, and precious metals such as K-gold and pure gold. In some embodiments of the present invention, they are implemented to be made of copper material. Adjust the size of the wearing space 100 of the earband type earphone 1 through the ductility of copper material, so that adapt to the car E of different groups of people. In addition, it is made of high-quality metal materials that can resist wear and damage during daily use, extending the service life of the earband type earphone 1. In other embodiments of the present invention, they also be made of materials such as ABS material (ternary copolymer of acrylonitrile, butadiene, and styrene), PP material (polypropylene), PC material (polycarbonate), rubber, silicone, etc.

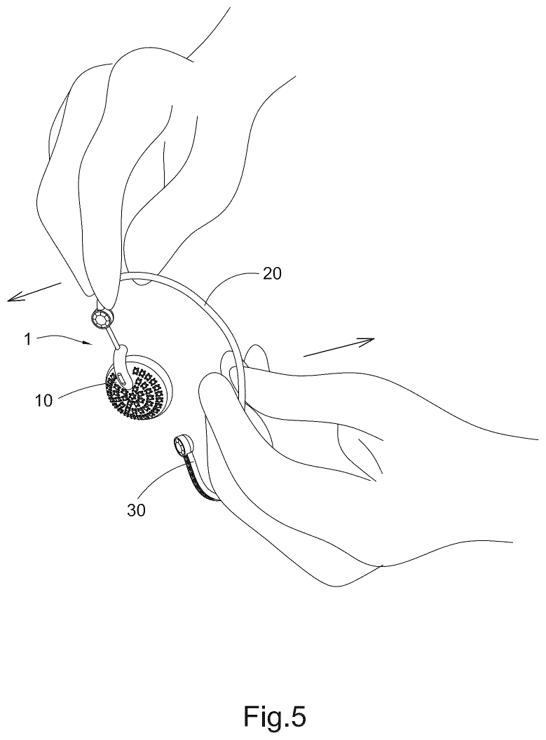

As shown in FIG. 5, when the wearer first wears the earband type earphone 1, if the wearer's helix E12 is large and the earband type earphone 1 cannot be worn, the wearing part 10 and the earlobe retention part 30 can be gently pulled in opposite directions to expand the wearing space 100 of the earband type earphone 1. If the wearer's helix E12 is small, the earband type earphone 1 can be easily worn, and the earband type earphone 1 may be relatively loose and can be gently driven to move the wearing part 10 and the earlobe retention part 30 in opposite directions. For example, pinch the wearing part 10 and the earlobe retention part 30 at both ends of the earband type earphone 1 by hand, so that the wearing part 10 and the earlobe retention part 30 are close to each other, reduce the wearing space 100 of the earband type earphone 1, so that it firmly adheres to the earlobe E13 of the wearer's ear E, and make the inner surface of the earlobe retention part 30 tightly adhere to the earlobe E13 of the wearer's ear E. When removing the earband type earphone 1 from the wearer's ear E, the wearer can pull the wearing part 10 and the earlobe retention part 30 in opposite directions, causing the earband type earphone 1 to detach from the wearer's ear E.

When the first wearing shell 111 of the wearing part 10, the connecting part 20, and the first clamping shell 3111 of the first clamping body 31 are integrally formed from a rigid material, that is, when the wearing space 100 of the earband type earphone 1 is inconvenient to be adjusted, the earband type earphone 1 can be moved downwards from the upper direction of the ear E, so that the upper part of the earband type earphone 1 can be slided along the auricle E1 of the ear E to an appropriate position: so that the the end of connecting part 20 of the earband type earphone 1 which is connected to wearing part 10 can be slided to the foot of the helix E12, and the wearing part 10 is suspended at the ear E corresponding position of the tragus E11; The various positions of ear E can be appropriately pulled or pressed, so that the other parts of the earband type earphone 1 are worn in the appropriate positions of ear E. The lower part of the connecting part 20 is located on the posterior side of the ear E, and the earlobe retaining part 30 is clamped at the earlobe E13. The first clamping body 31 of the earlobe retaining part 30 is located on the rear side of the earlobe E13, and the second clamping body 32 is located on the front side of the earlobe E13.

It is worth noting that the first wearing shell 111 of the wearing part 10, the connecting part 20, and the first clamping shell 3111 of the first clamping body 31 can be made of different materials, for example, the first wearing shell 111 of the wearing part 10 is made of plastic material; The first clamping shell 3111 of the first clamping body 31 is made of a material with strong transmission, thereby avoiding signal shielding, weakening signal reception and emission, and allowing the wearer to have a better wearing experience.

Alternatively, an outer cover layer may be provided on the outer surface of the wearing part 10 and/or the connecting part 20 and/or the earlobe retention part 30 to provide protection for the wearing part 10 and/or the connecting part 20 and/or the earlobe retention part 30. The outer cover layer can be made of flexible materials, which can improve the wearing comfort of the wearer.

The earband type earphone 1 also comprises a power supply unit 60 and a control unit 50. In this embodiment, the power supply unit 60 and the control unit 50 are electrically connected and installed in the second containment space 310 of the earlobe retention part 30. In this way, only the sounding unit 40 is provided within the wearing part 10, and the space within the wearing part 10 is mainly used to accommodate the sounding unit 40. Therefore, the size of the sound unit 40 can be larger, and the larger size of the sound unit 40 can provide better sound effects. It should be understood that one of the control unit 50 and the power supply unit 60 can also be installed inside the wearing part 10.

The power supply unit 60 comprises a battery, which can be a rechargeable battery and can be repeatedly charged to provide electrical energy for reuse. Correspondingly, the power supply unit 60 also comprises at least a charging portion electrically connected to the battery. The charging part can be implemented as a charging port, suitable for connecting a charging line, and the charging port is extended from the second containment space 310 of the earlobe retention part 30 to the outer surface of the first clamping body 31 of the earlobe retention part 30; The charging portion can also be implemented as a charging contact, suitable to collide with the charging contact in the charging compartment, and the charging contact is extended from the second containment space 310 of the earlobe retention part 30 to the outer side of the first clamping body 31 of the earlobe retention part 30.

The control unit 50 comprises a control circuit board 51 and at least a control operation element 52. The control operation element 52 is electrically connected to the control circuit board 51. Specifically, it can be connected to the control circuit board 51 through an electrical connection line 23 or integrated into the control circuit board 51. The control operation element 52 is used to control the state of the earband type earphone 1, thereby achieving volume adjustment, channel switching, on/off, and answering phone calls. Specifically, different adjustments can be achieved by controlling the operation time and number of operations of the control operation element 52. The wearer transmits signals to the control circuit board 51 by operating the control operating element 52, and then processes and issues instructions through the signal processing unit of the control circuit board 51 to achieve different functional adjustments.

Alternatively, the control operation element 52 can be implemented as a press type button or as other types of operation devices, such as a joystick type or touch sensing type. The control operation element 52 is extended from the second containment space 310 of the earlobe retention part 30 to the outer side of the earlobe retention part 30 or other positions, and may not exceed the outer surface of the earlobe retention part 30.

It can be understood that the control circuit board 51 of the earband type earphone 1 can be integrated with a communication module and a microphone. Among them, the microphone is used to collect voice commands from the wearer and transmit them to the communication module. An intelligent analysis module such as an artificial intelligence module can be integrated with the control circuit board 51, which can improve its interaction with the terminal device and the wearer. For example, by interacting with the terminal device, it can not only control the playback of audio and video, make phone calls, but also provide network information to the wearer, conduct online shopping, send emails, control home or office devices, etc.

For example, the earband type earphone 1 can serve as an intelligent voice interaction terminal device. When the wearer wears the earband type earphone 1 to drive a new energy vehicle, the wearer of the earband type earphone 1 sends a “defogging” voice command to the earband type earphone 1, after receiving the wearer's command, the communication module sends a “defogging” command to the car's sensing system. The car automatically starts the defogging mode after receiving the signal transmitted by the communication module. When wearer of the earband type earphone 1 sends a voice command of “automatic parking” to the earband type earphone 1, the communication module receives the wearer's command and transmits the “automatic parking” command to the car's sensing system. After receiving the signal transmitted by the communication module, the car automatically enters automatic parking mode. It can be understood that the voice interaction here is only for example, and the earband type earphone 1 can also be more widely applied to various intelligent interaction scenarios in life and work, such as smart home control, intelligent office, intelligent communication, intelligent driving, intelligent medical care, etc.

That is, the earband type earphone 1 of the present invention can be worn for a long time, without pain, without discomfort, and can avoid hearing damage. Therefore, the earband type earphone 1 can be worn on the wearer's ear E for a long time as an artificial intelligence assistant device. It obtains instructions in real-time through audio, recognizes and processes collected information, feeds back operations based on semantic results, and finally performs corresponding intelligent control work.

It is worth mentioning that the microphone can be built-in with algorithms to have noise reduction effects, that is, the microphone can reduce the noise in the environment when receiving the wearer's voice commands, so that the microphone can obtain a purer wearer's voice.

The control circuit board 51 can also be integrated with a hearing aid unit 80, which is located within the earlobe retention part 30. The hearing aid unit 80 comprises an amplifier, a receiver, and other structures, wherein sound can be collected through the microphone and converted into electrical waves, the amplifier is used to increase the intensity of the electrical waves, and the receiver is used to convert electrical energy back into sound waves. The hearing aid unit 80 has the function of assisting users in auditory restoration. The control circuit board 51 coordinates the output relationship between the hearing aid unit 80 and the sounding unit 40 during the wearing process of the earband type earphone 1.

Specifically, the earband type earphone 1 combines a hearing aid with the earphone, that is, the earband type earphone 1 concentrates the sound output and hearing aid functions. In other words, the earband type earphone 1 can both answer and make calls, as well as assist users in listening. The earband type earphone 1 can switch between two situations independently. When a phone call comes in, the control circuit board 51 processes the signal and connects to the phone through Bluetooth, switching to the function of making a phone call. Usually, it can be used as a hearing aid for users with poor hearing, avoiding the phenomenon of earphones and hearing aids occupying the user's ear canal together, resulting in insufficient space, and avoiding a series of troubles. That is, the earband type earphone 1 can be compatible with hearing aid functions, which can avoid the problem of hearing impaired wearers being unable to wear hearing aids while wearing the earphone.

The earband type earphone 1 can be equipped with other intelligent sensors, such as an optical heart rate sensor, which is installed in the second containment space 310 or the first containment space 110, and is located on the inner side of the earband type earphone 1, that is, near the wearer's ear E. The light reflected back through skin tissue is received by the optical heart rate sensor and converted into an electrical signal, which is then converted into an audio signal. Finally, it is broadcasted to the wearer through the sounding unit 40, which is used to measure the wearer's heart rate.

The earband type earphone 1 can also include a temperature sensor, which is installed in the second containment space 310 or the first containment space 110, and is located on the inner side of the earband type earphone 1, that is, near the wearer's ear E. The body temperature emitted through skin tissue is received by the temperature sensor and converted into an audio signal, which is finally broadcasted to the wearer through the sounding unit 40 for measuring the wearer's body temperature.

It should be noted that in order to balance the weight of the earband type earphone 1, it can be configured to ensure that the weight of the wearing part 10 and the earlobe retention part 30 located on both sides of the wearer's helix E12 are basically the same, thereby avoiding discomfort for the wearer when wearing the earband type earphone 1 due to uneven weight on both sides of the helix E12.

It is worth mentioning that the connecting part 20 comprises a connecting body 21 and has at least a wiring channel 22, wherein the wiring channel 22 is formed inside the connecting body 21 or on the surface of the connecting body 21 concavely. When the wiring channel 22 is concavely formed on the surface of the connecting body 21, it is preferably located on the inner side of the earband type earphone 1, that is, facing the side of the wearing space 100. It can be understood that when the wiring channel 22 is concavely formed on the surface of the connecting body 21, it can also be located on the outer side of the earband type earphone 1, that is, the side away from the wearing space 100.

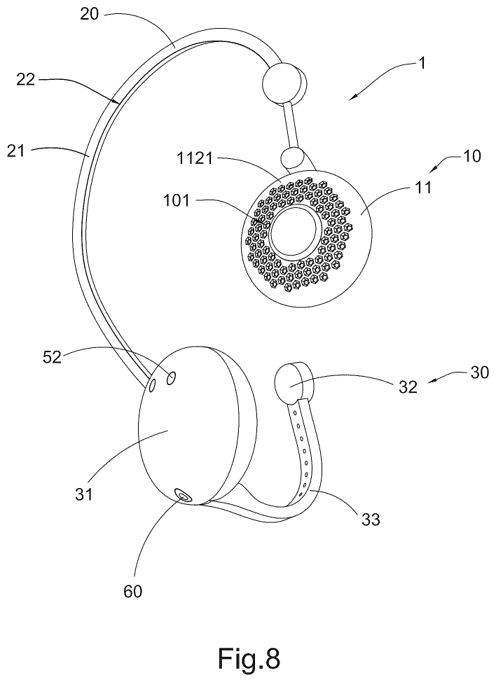

Furthermore, as shown in FIG. 8, according to a deformation embodiment, the wiring channel 22 is formed in a concave manner on the surface of the connecting body 21, as implemented along the inner surface of the connecting body 21. In this way, when the connecting body 21 is made of metal materials such as stainless steel, the connecting part 20 does not allow the user to grip the wearing part 10 and the earlobe retention part 30 to move in a direction that makes them relative to each other and away from or close to each other, but the connecting part 20 allows it to twist to its side under the action of external force to adjust the position of the wearing part 10 and the earlobe retention part 30, which is just suitable and convenient for the user to adjust the fitting position of the wearing part 10 and the earlobe retention part 30 on the ear E.

The connecting part 20 further includes a set of electrical connection lines 23, which are arranged in the wiring channel 22 to electrically connect the sounding unit 40 to the control circuit board 51, so that the audio signals can be transmited by the control circuit board 51 to the sounding unit 40.

The electrical connection lines 23 can be exposed to the outside, thereby playing a decorative role by selecting a suitable color to match the connection part 20.

The outer surface of the earband type earphone 1 can be decorated with decorative elements, such as diamonds, pearls, colored treasures, relief patterns, textures, etc., so that the earband type earphone 1 itself can be used as an earring. Correspondingly, in some embodiments of the present invention, the earband type earphone 1 comprises at least a decorative element 70. The implementation method and setting position of the decorative element 70 are not limited by the present invention. The decorative element 70 can be implemented as diamonds, pearls, colored treasures, relief patterns, textures, etc. The decorative element 70 can be located on at least a portion of the wearing part 10, the connecting part 20, and the earlobe retention part 30, particularly on the outer surface of the wearing part 10, the portion of the connecting part 20 located in front of the ear, or the outer surface of the second clamping body 32 and the connecting element 33 of the earlobe retention part 30.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An earband type earphone, comprising:
a wearing part;
an earlobe retention part; and
A connecting part; wherein said connecting part is connected between said wearing part and said earlobe retention part, so that said wearing part is suitable for being suspended at a position corresponding to said tragus of the ear, and a clamping cavity is formed by said earlobe retention part, so that the earlobe is suitable for being located in said clamping cavity and being clamped by said earlobe retention part.

2. The earband type earphone, as recited in claim 1, wherein the end of said connecting part of said earband type earphone which is connected to said wearing part is located at the foot of the helix when said earband type earphone is worn by the wearer, and the wearing part is located below one end of the connecting part.

3. The earband type earphone, as recited in claim 2, wherein the upper part of said connecting part adjacent to said wearing part is surrounded the front side of the helix of the ear, and the lower part of said connecting part is surrounded the back side of the ear.

4. The earband type earphone, as recited in claim 2, wherein said wearing part comprises a wearing body and a sounding unit, wherein said wearing has a first containment space and said sounding unit is accommodated within said first containment space, when the user wears said earband type earphone, said sounding unit is corresponding to the cavum conchae of the ear.

5. The earband type earphone, as recited in claim 1, wherein said earlobe retention part comprises a first clamping body, a second clamping body and a connecting element, wherein said first clamping body, said second clamping body and said connecting element are enclosed to form said clamping cavity, wherein said first clamping body is located at the rear side of the earlobe, and the second clamping body is located at the front side of the earlobe.

6. The earband type earphone, as recited in claim 5, wherein said second clamping body is constructed to have a decorative effect.

7. The earband type earphone, as recited in claim 5, wherein said eralope retention part has a second containment space, said earband type earphone further comprises a power supply unit and a control unit, said power supply unit and said control unit are accommodated within said second containment space.

8. The earband type earphone, as recited in claim 1, wherein a wearing space is formed by said wearing part, said connecting part and said earlope retention part, and the size of said wearing space is adjustable.

9. The earband type earphone, as recited in claim 3, wherein said connecting part is made of deformable material, so that the size of said wearing space is adjustable.

10. The earband type earphone, as recited in claim 4, wherein said connecting part is elastic.

11. The earband type earphone, as recited in claim 1, wherein said earband type earphone further comprises a control unit and a hearing aid unit, wherein said control unit comprises a control circuit board and at least a control operating element, and said hearing aid unit is connected to said control circuit board.

12. The earband type earphone, as recited in claim 1, wherein said earband type earphone further comprises a control unit, said control unit comprises a control circuit board and at least a control operating element, wherein said control circuit board is integrated with at least a microphone and an artificial intelligence module.

13. The earband type earphone, as recited in claim 1, wherein said connecting part comprises a connecting body and a wiring channel, wherein said wiring channel is formed within said connecting body.

14. The earband type earphone, as recited in claim 1, wherein said connecting part comprises a connecting body and a wiring channel, wherein said wiring channel is concavely formed on the outer surface of said connecting body.

15. The earband type earphone, as recited in claim 1, wherein said earband type earphone further comprises at least a decorative element, which is provided on at least a portion of the surface of said wearing part, said connecting part, and said earlobe retention part.
